(19) United States
(12) Patent Application Publication
(10) Pub. No.: US 2025/0314507 A1
(43) Pub. Date: Oct. 9, 2025

(54) EXCEPTIONAL-POINT-ENHANCED REMOTE PHASE SENSING

(71) Applicant: Washington University, St. Louis, MO (US)

(72) Inventors: Wenbo Mao, St. Louis, MO (US); Lan Yang, St. Louis, MO (US)

(21) Appl. No.: 19/169,627

(22) Filed: Apr. 3, 2025

Related U.S. Application Data
(60) Provisional application No. 63/574,495, filed on Apr. 4, 2024.

(51) Int. Cl. G01D 5/353

(52) U.S. Cl. CPC G01D 5/35361

(57) ABSTRACT

Systems and methods for enhancing sensitivity in a sensor with exceptional points (EPs), including: providing a sensor in the form of an exception-point (EP)-enhanced sensor; providing one or optical fibers associated with the EP-enhanced sensor; providing a scatterer; and/or providing a reflective component, the reflective component influencing a mode coupling of the EP-enhanced sensor. Where the sensor is a microresonator: coupling one or more modes of the microresonator via a bidirectional coupling channel and a unidirectional coupling channel; manipulating the mode coupling by a scatterer and a reflective component, the reflective component influencing the mode coupling of the resonator; steering, via the reflective component, the microresonator around EPs; and/or sending, via the reflective component, one or more phase changes in response to external perturbations back to the microresonator.

### CROSS-REFERENCE TO RELATED APPLICATIONS

This Application claims the benefit of priority to U.S. Provisional Application Ser. No. 63/574,495 filed on Apr. 4, 2024, the entire contents and disclosures of which is incorporated herein by reference in its entirety.

U.S. patent application Ser. No. 15/430,426 filed on Feb. 10, 2017 claims priority to (i) U.S. Provisional Patent Application No. 62/293,746, filed on Feb. 10, 2016 and (ii) U.S. Provisional Patent Application No. 62/333,667, filed on May 9, 2016. U.S. patent application Ser. No. 15/981,228 filed on May 16, 2018, now U.S. Pat. No. 11,131,619, is a continuation application of U.S. patent application Ser. No. 15/430,426. U.S. patent application Ser. No. 17/446,525 filed on Aug. 31, 2021, now U.S. Pat. No. 11,754,488, is a continuation application of U.S. patent application Ser. No. 15/981,228. U.S. patent application Ser. No. 18/322,118 filed on May 23, 2023, now U.S. Pat. No. 12,247,909, is a continuation application of U.S. patent application Ser. No. 17/446,525. U.S. patent application Ser. No. 18/747,516 filed on Jun. 19, 2024, is a continuation application of U.S. patent application Ser. No. 18/322,118. The contents of all the aforementioned U.S. patent applications and U.S. patents are hereby incorporated by reference herein in their respective entireties.

### FIELD OF THE DISCLOSURE

The field of the invention relates generally to sensors and sensing systems, including but not limited to optical sensors and properties thereof, such as Exceptional Points. The sensors and sensor platforms are useful in a variety of applications including detection and monitoring.

### BACKGROUND OF THE DISCLOSURE

Conventionally, displacement sensors, such as accelerometers, linear variable differential transformers, strain gauges, and piezoelectric sensors, etc., are mainly based on electronic and magnetic techniques. While widely used, these sensors pose many economic and practical challenges, including their low spatial sensing resolutions, sparse and discrete point-wise measurements, sensitivity to electromagnetic interference, and vulnerability to humidity and corrosiveness.

On the other hand, optical sensors offer significant advantages over conventional ones by providing such features as high precision, small footprint, resistance to electro-magnetic interference, and low cost. Optical sensors leveraging phase change have become an important component in applications ranging from gravitational wave detection to cellular apoptosis monitoring. In recent years, plentiful fascinating phenomena have been demonstrated in non-Hermitian optical/photonic systems. For example, Exceptional Points (EPs), as spectral singularities in non-Hermitian systems, have been exploited to enhance the sensitivity of optical sensors due to their strong response to perturbations. EPs, as degeneracies in non-Hermitian systems, are ultra-sensitive to perturbations and have been proven to improve the sensitivity of sensors. However, current EP-enhanced optical sensors are elaborately designed for specific and limited targets. That is, current EP-enhanced optical sensors are usually designed for specific targets that directly interact with structures at EP states. This means that the universality of EP enhancement is restricted.

Additionally, a variety of different optical sensors (e.g., optical displacement sensors) have been developed over the past decade, including Mach-Zehnder interferometers (MZI), Sagnac interferometers, photonic crystal fibers, bent fiber structures, and multimode interference fiber structures. However, these sensors have relatively low sensitivity due to the limited optical path constrained by the physical dimensions of the structures.

Yet further, in numerous physical, chemical, and/or biological processes, various parameters change simultaneously. To fully understand these complex processes, it is necessary to simultaneously gather information on these diverse changes. Multiparameter sensing technologies are pivotal in these scenarios, as they concurrently capture a wide range of parameters at once, offering essential insights into complex process dynamics. For instance, in human health monitoring, parameters such as heart rate, blood oxygen levels, and temperature can give vital clues about the body's state. By tracking these parameters together, healthcare professionals can make more accurate diagnoses and treatment plans. In robotics, incorporating multiparameter sensing is key for enabling robots to interact with their environment and humans effectively and safely. Conventionally, multiplexed sensors include multiple individual sensors, each tailored to detect a specific parameter. They can also measure the same parameter at different locations, aiding in spatially mapping variations or providing less uncertainty and better overall sensing capabilities. However, each sensor needs individual calibration and maintenance, which is both time-consuming and resource-intensive. The complex manufacturing process and restricted sensor types limit their further integration and application.

What is needed is (e.g., real-time) monitoring of displacement and/or other properties with high precision in many fields, such as imaging, astronautics, robotics, civil engineering, and structural health monitoring.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

In one aspect, a phase sensing platform comprising one or more optical sensors with exceptional points (EPs) enhancement of sensitivity. The phase sensing platform includes: a sensor configured as an exception-point (EP)-enhanced sensor; one or optical fibers associated with the EP-enhanced sensor; a scatterer; and a reflective component. The reflective component is configured to influence a mode coupling of the EP-enhanced sensor.

In another aspect, a method of enhancing sensitivity of one or more optical sensors with exceptional points (EPs). The method includes: providing a sensor configured as an exception-point (EP)-enhanced sensor; providing one or optical fibers associated with the EP-enhanced sensor; providing a scatterer; and providing a reflective component. The reflective component is configured to influence a mode coupling of the EP-enhanced sensor.

In yet another aspect, a method of enhancing sensitivity in a microresonator with exceptional points (EPs). The method includes: coupling one or more modes of the microresonator via a bidirectional coupling channel and a unidirectional coupling channel; and manipulating the mode coupling by a scatterer and a reflective component. The reflective component is configured to influence the mode coupling of the microresonator. The method further includes steering, via the reflective component, the microresonator around EPs; and sending, via the reflective component, one or more phase changes in response to external perturbations back to the microresonator.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### DESCRIPTION OF DRAWINGS

The patent or application file contains at least one drawing executed in color. Copies of this patent or patent application publication with color drawing(s) will be provided by the Office upon request and payment of the necessary fee.

The accompanying drawings, which are incorporated in and form a part of the specification, illustrate the embodiments of the present disclosure and together with the description, serve to explain the principles of the disclosure. Those of skill in the art will understand that the drawings, described below, are for illustrative purposes only. The drawings are not intended to limit the scope of the present disclosure in any way.

FIG. 1A illustrates an Exceptional-Point-enhanced (EP-enhanced) remote phase sensing platform according to one embodiment of the present disclosure.

FIG. 1B illustrates modes of a sensor of the EP-enhanced remote phase sensing platform according to FIG. 1A.

FIG. 1C illustrates various EP states of the EP-enhanced remote phase sensing platform according to FIG. 1A.

FIG. 1D illustrates a topology of a surface that characterizes a real part of complex eigenvalues of the EP-enhanced remote phase sensing platform according to FIG. 1A.

FIG. 1E illustrates a topology of a surface that characterizes an imaginary part of the complex eigenvalues of the EP-enhanced remote phase sensing platform according to FIG. 1A.

FIG. 1F illustrates a schematic diagram of an EP-enhanced phase sensing platform according to one embodiment of the present disclosure.

FIG. 2A illustrates a finite-element simulation of eigenmodes and experimental results of chiral properties for the EP-enhanced system shown in FIG. 1A at a non-EP state.

FIG. 2B illustrates plots of the finite-element simulation according to FIG. 2A.

FIG. 2C illustrates a finite-element simulation of eigenmodes and experimental results of chiral properties for the EP-enhanced system shown in FIG. 1A at an EP state.

FIG. 2D illustrates plots of the finite-element simulation according to FIG. 2C.

FIG. 2E illustrates a plot for measurements of the chirality corresponding to the plots shown in FIGS. 2B and 2D.

FIG. 3A illustrates plots for frequency splitting and linewidth difference as varying phase perturbation at a coupling regime according to one embodiment of the present disclosure.

FIG. 3B illustrates plots for transmission spectra corresponding to FIG. 3A.

FIG. 3C illustrates plots for frequency splitting and linewidth difference as varying phase perturbation at another coupling regime according to one embodiment of the present disclosure.

FIG. 3D illustrates plots for transmission spectra corresponding to FIG. 3C.

FIG. 3E illustrates plots for frequency splitting and linewidth difference as varying phase perturbation at yet another coupling regime according to one embodiment of the present disclosure.

FIG. 3F illustrates plots for transmission spectra corresponding to FIG. 3E.

FIG. 4A illustrates a plot for EP-enhanced fiber strain sensing of a reflection-type non-resonant strain sensor according to one embodiment of the present disclosure.

FIG. 4B illustrates a plot for changes of frequency splitting as applying pulsed strains corresponding to FIG. 4A.

FIG. 4C illustrates plots for frequency splitting in response to the pulsed strains according to FIG. 4B

FIG. 4D illustrates a plot for a transmission-type resonant strain sensor according to one embodiment of the present disclosure.

FIG. 4E illustrates a plot for changes of frequency splitting as applying pulsed strains corresponding to FIG. 4D.

FIG. 4F illustrates a plot for frequency splitting with the strains increasing according to one embodiment of the present disclosure.

FIG. 4G illustrates plots for transmission spectra as applying stronger strains correspond to FIG. 4E.

FIG. 4H illustrates a plot for changes of frequency splitting as applying pulsed strains at different coupling strengths

FIG. 5 is a flow diagram of an example method according to one embodiment of the disclosure.

FIG. 6 is a block diagram schematically illustrating an example system in accordance with one embodiment of the disclosure.

FIG. 7 illustrates an example component configuration of a computing device according to one embodiment of the disclosure.

FIG. 8 illustrates an example configuration of a remote or user computing device according to one embodiment of the disclosure.

FIG. 9 illustrates an example configuration of a server system according to one embodiment of the disclosure.

There are shown in the drawings arrangements that are presently discussed, it being understood, however, that the present embodiments are not limited to the precise arrangements and are instrumentalities shown. While multiple embodiments are disclosed, still other embodiments of the present disclosure will become apparent to those skilled in the art from the following detailed description, which shows and describes illustrative aspects of the disclosure. As will be realized, the invention is capable of modifications in various aspects, all without departing from the spirit and scope of the present disclosure. Accordingly, the drawings and detailed description are to be regarded as illustrative in nature and not restrictive.

### DETAILED DESCRIPTION

Disclosed herein are systems and methods for a novel phase sensing platform that incorporates conventional optical sensors with an EP enhancement of sensitivity. In some embodiments, conventional sensors are connected to a microresonator via an optical fiber, functioning as a “remote scatterer.” The EPs described herein may be realized in parameter space by tuning sensors such as whispering-gallery-mode (WGM) microresonators, for example. Innovatively, compared to prior techniques, one of two surface scatterers is replaced by a fiber-based reflective component. The reflective component, or a functional “remote scatterer,” can be constructed from a conventional optical sensor, which returns the phase perturbation to the microresonator.

The systems and methods described herein further include experimental investigation of the EP-enhanced change of spectral characteristics—the splitting of resonance—with a perturbed optical sensor. A 5.9-fold improvement of the detection limit for fiber strains as an application is demonstrated. Furthermore, the universality of the sensing platform described herein is emphasized, owing to the amplification of optical phase change by EPs, a general physical quantity that almost all optical sensors can provide.

The sensitivity of various existing optical sensors can be improved by the EP system described herein, such as for applications including but not limited to environmental detection, health monitoring, and/or biomedical imaging. The platform described herein also reduces the cost of realizing EP sensors. The existing conventional sensors, either whispering-gallery resonators, photonic crystals, Fabry-Perot cavities, or fiber-based sensors, for example, can connect with the system described herein via an optical fiber to obtain superior sensing performance without further modification to the sensors.

As described herein, EPs are the spectral singularities of non-Hermitian systems, at which the eigenvalues and the corresponding eigenstates coalesce. Such degenerate points have been observed in optical microcavities, plasmonic metamaterials, photonic crystals, acoustics, electronics, and superconducting circuits. In particular, plentiful extraordinary phenomena are revealed in non-Hermitian optics and photonics. For example, as a result of strong chiral behaviors in the vicinity of an EP, directional microlasers can be achieved in whispering-gallery-mode (WGM) microresonators with two Rayleigh scatterers. Quantum emission with modified density of states has also been theoretically studied in photonic crystals and WGM resonators. In addition, the control of light near EPs has also been extensively investigated, such as electromagnetically induced transparency and coherent perfect absorption. Chiral mode conversion and switching have been exhibited by dynamically cycling an EP, embodying its topological properties.

Another attractive feature of EPs is their distinctive sensitivity to perturbations. The splitting of resonance in a system around trivial degeneracies, so-called diabolic points (DPs), is proportional to the perturbation ϵ. In contrast, the resulting splitting scales as ϵ^{1/N} for the case of an Nth-order EP where N eigenstates coalesce. The splitting enhancement factor ϵ^{-(N-1)/N} tends to the infinity for the sufficiently small perturbation ϵ→0. The EP-enhanced optical sensors have been demonstrated for nanoparticle detection, thermal sensing, rotation sensing, and biomolecules detection. All of them require the detected perturbations to be inside or near the optical structures tuned at EPs. The sensing targets should be only wavelength-scale away from WGM resonators or plasmonic cavities. In other words, these optical structures are not only the unit realizing EPs, but also serve as a sensor to detect perturbations. As for sensing applications in complex situations, unwanted environmental fluctuations can deviate the optical structures from the delicate EP states and lead to drastic noises, which limits the application of EP-enhanced sensors.

In contrast, conventional optical sensors, as counterparts of non-Hermitian sensors, have been demonstrated in various applications, such as temperature monitoring, vibration detection, particle/molecule sensing, magnetometer, and ultrasound imaging. Their mature packaging techniques efficiently protect them from unnecessary fluctuations. The detected signals can be measured from the spectral characteristics of optical structures, such as frequency shift, linewidth broadening, and splitting of resonant mode. Fundamentally, the spectral changes stem from variations in the phase of light induced by the sensing targets. Thus, it is of critical importance to construct an EP system that can amplify the phase change and improve the sensitivity of existing conventional optical sensors.

Further regarding optical sensors, and specifically optical resonators (e.g., a class of optical devices with a superior capability to confine light within a small volume), resonators are promising candidates to overcome the limitations of other sensors as described herein. For example, in a high-quality resonator, light could circulate along a closed loop over millions of times, which increases the effective optical path beyond the physical dimension of the structure and significantly enhances the light-matter interactions, leading to significantly improved sensitivity. In addition, the high Q-factor of a resonator leads to a narrow bandwidth in the spectrum, making it easier to resolve subtle changes. Among various kinds of optical resonator sensors, whispering-gallery-mode (WGM) resonators have attracted increasing attention due to their exceptionally high Q-factor, fast dynamic response, and high sensitivity. The advances in WGM resonators have demonstrated their promise for a broad range of applications, including non-Hermitian and topological photonics, optomechanical solitons, cavity quantum electrodynamics, nonlinear optics, low threshold lasers, and optical sensors. These devices offer the advantages of high Q-factor, small mode volume, and strong light-matter interaction enabling high sensitivity. Fiber tapers have been used as an efficient tool to couple light in and out of WGM resonators. Typically, WGMs are excited and detected via a tapered fiber coupled to a resonator.

Taking the above into account, the systems and methods described herein utilize EP states for ultrasensitive detection of phase changes in light. More specifically, one of the scatterers, used for steering in parameter space of the reported EPs, is replaced by a functional “remote scatterer” in the system disclosed herein. The definition of scattering is extended to a fiber-based reflective component, which sends back the phase change to the EP resonator. The reflective component, also referred to as a sensing unit as described herein, can be constructed from any optical sensor, either reflection-or transmission-type, or non-resonant or resonant, theoretically as long as it provides a phase change as being perturbed. In the design described herein, the control unit for tuning EP states and the sensing unit for detecting perturbations can be separated by meter-scale. The detachment of two units gives the chance to connect the non-Hermitian physics with various widely used conventional optical sensors. The EP realized by the control unit enhances the magnitude of frequency splitting as one of the spectral characteristics induced by phase perturbations. In other words, the ability for detecting tiny perturbations, or the sensitivity of a sensor, can be improved by EP states. The EP-enhanced detection limit of fiber strain sensors are demonstrated herein as an example of the novel sensing platform described herein.

The detection limit of the platform described herein is derived from the fluctuation of splitting at EPs. The mechanical instability causes variations of u and do that are critical for realizing an EP. For example, the airflow and the vibration of the optical table can lead to the varying gap between the tapered fiber and the microtoroid, as well as the unnecessary phase change of the unfixed fiber that connects the control unit and sensing unit. The uncompensated thermal drifting of the piezo components in the translation stages or in the phase shifter is also an origin of mechanical instability.

In summary, described herein is a novel sensing platform constructed to realize the enhancement of sensitivity, leveraging the square-root topologic features around EPs in response to perturbations. The platform can apply the EP enhancement to various existing conventional optical sensors, including WGR, FPR, PhC, and fiber-based sensors. This universality is benefited from a general physical quantity aimed in the EP system described herein, optical phase, since almost all the optical sensors have the phase response to perturbations. EP-enhanced high-sensitivity environmental detection, health monitoring, biomedical imaging is able to be achieved by connecting applicable optical sensors to the sensing platform described herein. Additionally, techniques of photonic integrated circuits described herein, in which all the components, including optical waveguides, resonators, and phase shifters, are fabricated on a chip, help improve mechanical stability and obtain a better detection limit of the design described herein. The EP-enhanced phase sensing platform described herein is building a bridge between non-Hermitian physics and the flourishing optical sensing community.

In various aspects, the performance of the sensors and systems described herein may be assessed using any suitable existing analysis method without limitation.

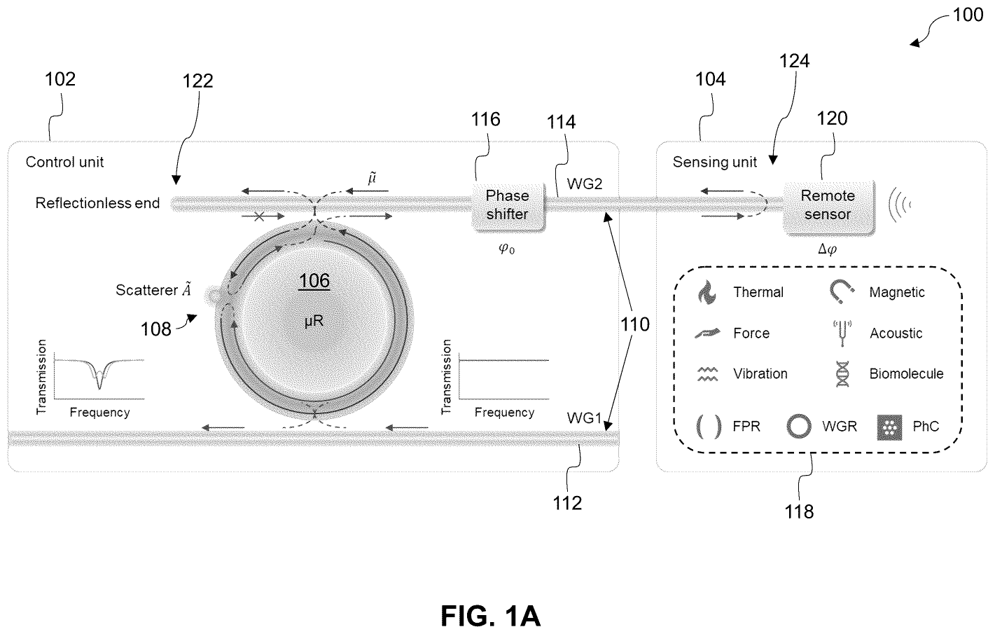

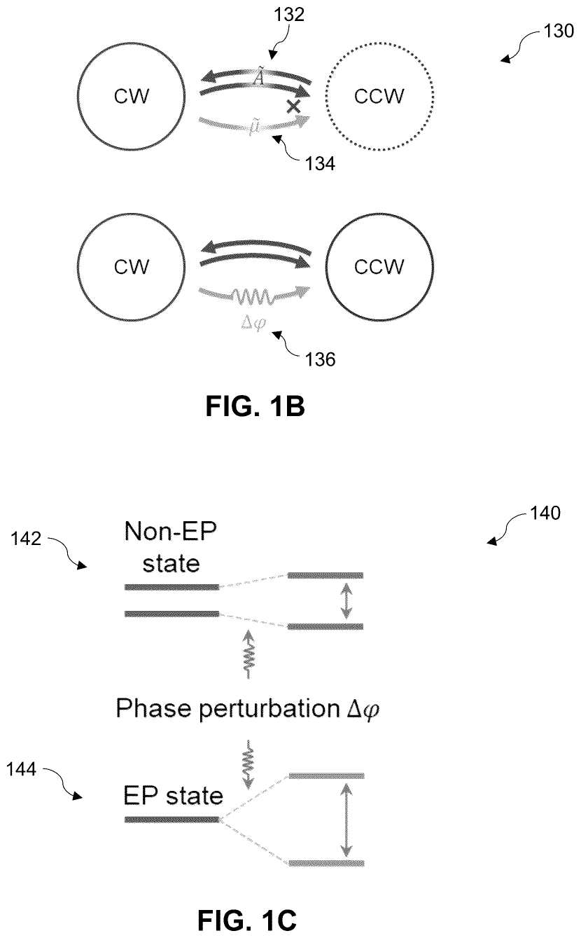

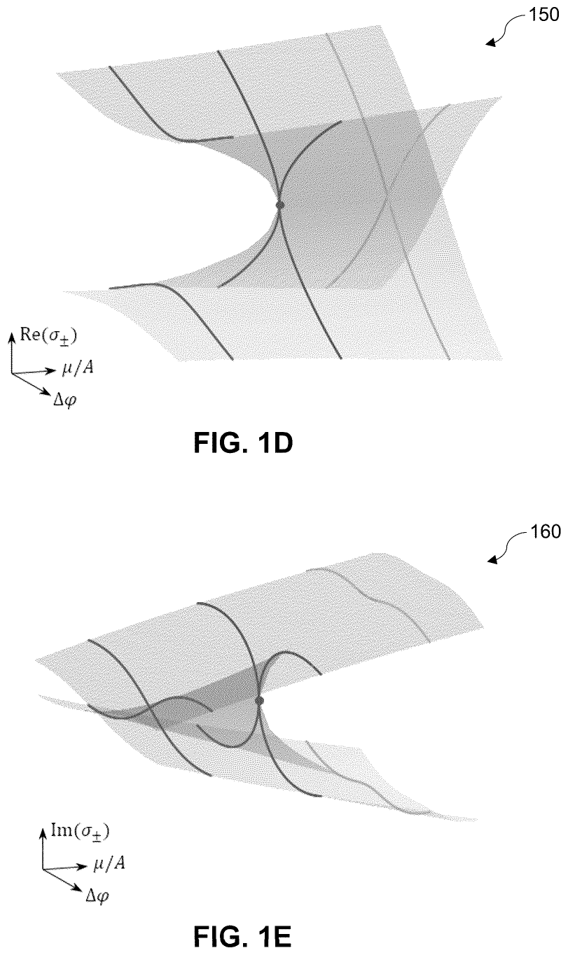

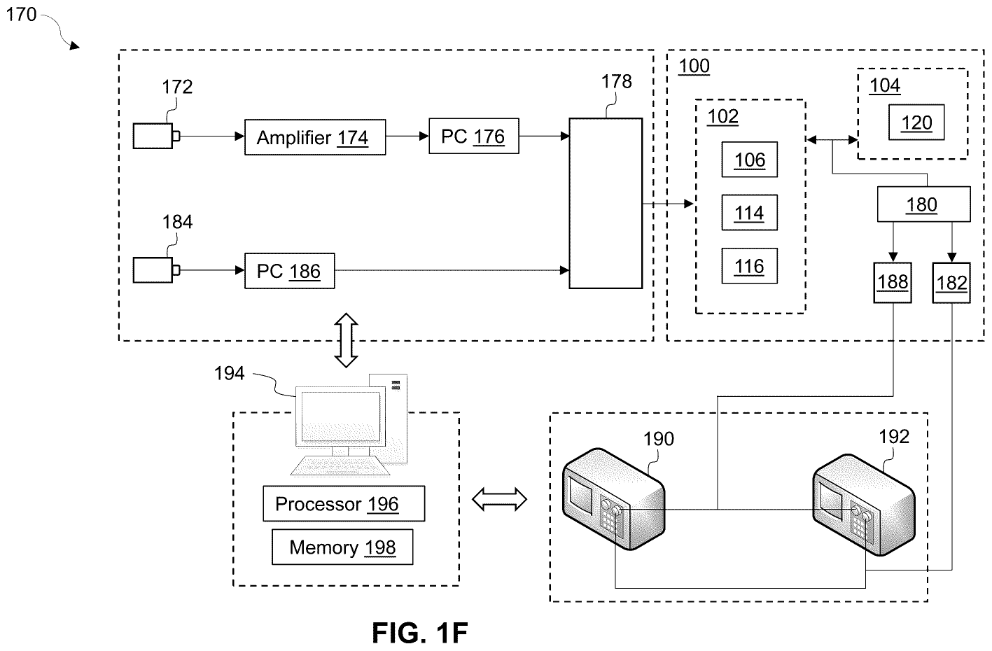

FIGS. 1A-1E illustrate a novel sensing platform according to one embodiment of the present disclosure.

FIG. 1A illustrates an EP-enhanced remote phase sensing platform 100 including a control unit 102 and a sensing unit 104. Control unit 102 includes, for example, a microtoroid WGM resonator 106, in which a bidirectional coupling channel Ã and a unidirectional coupling channel u are achieved by a Rayleigh scatterer 108 and one or more fibers (e.g., waveguides (WG)) 110, including a first waveguide WG1 (112) and a second waveguide WG2 (114), at least one of which being connected with sensing unit 104, respectively. Bidirectional may refer to clockwise (CW) and counterclockwise (CCW). Control unit 102 also includes additional components such as a phase shifter 116 and/or is used in association with other components as described in connection with FIG. 1F. Sensing unit 104 can be various types of sensors 118 such as optical sensors, as long as returning a phase change. These sensors 118 may function as a remote sensor 120 and include one of a Fabry-Pérot resonator (FPR), a whispering-gallery resonator (WGR), a photonic crystal (PhC), or other sensors as illustrated in FIG. 1A (e.g., thermal, magnetic, force, acoustic, vibration, biomolecule, etc.).

FIG. 1B illustrates a diagram 130 of CW and CCW modes coupled by bidirectional coupling channel Ã (132) and unidirectional coupling channel \tilde{μ} (134). At an EP state, one of the coupling directions (e.g., CW-to-CCW) is cancelled by the destructive interference of two coupling channels, leading to the coalescence of two eigenmodes. With a phase perturbation Δφ (136), the interference is no longer completely destructive. As a result, the cancelled coupling direction is recovered, and the system is detuned away from the EP state.

FIG. 1C illustrates a diagram 140 comparing a (e.g., uncoalesced) non-EP state 142 and an (e.g., coalesced) EP state 144. Compared with uncoalesced non-EP state 142, coalesced EP state 144 has a more significant response to a phase perturbation Δ® (e.g., such as a phase perturbation Δφ 136), embodied as the splitting of two eigenmodes.

FIGS. 1D and 1E illustrate diagrams 150 and 160 of a topology of surfaces that characterize a real part (FIG. 1D) and an imaginary part (FIG. 1E) of the complex eigenvalues σ_{±}, indicating the frequency splitting and linewidth difference of two eigenmodes, respectively. In particular, the response to a sufficiently small perturbation around an EP, labelled by purple points, is more drastic than those at non-EP states.

FIG. 1F illustrates a schematic diagram for an implementation of a setup 170 for sensing platform 100 shown in FIG. 1A. Setup 170 may be implemented as a test setup used to conduct experiments as described herein and may include one or more light sources such as lasers, components such as amplifiers, couplers, multiplexers, controllers, and the like, various detection and/or measurement components and/or instruments such as diodes, oscilloscopes, spectrum analyzers, and the like. More specifically, setup 170 may include a pump laser, a probe laser, one or more polarization controllers (PC), an amplifier, a multiplexer, a coupler, one or more photodetectors (PD), a spectrum analyzer, an oscilloscope, and a computer system configured to control setup 170.

In one embodiment, setup 170 includes pump laser 172, amplifier 174, PC 176, coupler 178, multiplexer 180, PD 182, probe laser 184, PC 186, PD 188, analyzer 190, oscilloscope 192, and computer device 194. Computer device 194 includes at least one processor 196 in operative communication with at least one memory 198. In some embodiments, pump laser 172 may be an external cavity laser (e.g., a tunable external cavity laser diode (ECLD) in the 1550 nm band), amplifier 174 may be an erbium-doped fiber amplifier (EDFA), coupler 178 may be a 50/50 coupler (e.g., 2-to-1 fiber coupler), multiplexer 180 may be a wavelength division multiplexer (WDM), probe laser 184 may be an external cavity laser with emission in the 980 nm band, and analyzer 190 may be an electrical spectrum analyzer (ESA). These are mere examples and other types of components and/or instruments may be implemented.

In operation, light from pump laser 172 is first amplified by amplifier 174 and then coupled into microtoroid resonator 106 of sensing platform 100 to act as the pump for the excitation of the (e.g., mechanical or propagation) modes. Optical transmission spectrum is obtained by scanning the wavelength of pump laser 172. The power of probe laser 184 may be selected such that it does not induce any thermal or mechanical effect on the resonator (e.g., the laser power is well below the threshold of mechanical oscillations). The transmission spectra of the pump and the probe fields are separately monitored by PDs 182/188 connected to analyzer 190 and oscilloscope 192. PCs 176/186 are utilized for control. A section of the fiber (e.g., 114) may be tapered, to enable efficient coupling of the pump and probe fields into and out of microtoroid resonator 106 and to remote sensor 120 as shown in FIG. 1A. The pump and probe fields in the transmitted signals are separated from each other using multiplexer 180 and then sent to the two separate PDs 182/188. The electrical signals from PDs 182/188 are then fed to oscilloscope 192, in order to monitor the time-domain behavior, and also to analyzer 190 to obtain the power spectra. Computer device 194 may provide control to setup 170, including controlling lasers 172/184 and the various components (e.g., 174, 176, 178, 180, 182, 186, 188, 190, an/or 192) as well as control for platform 100. One or more computer devices 194 may be implemented for control.

One approach to realizing EPs in microresonators is manipulating the mode coupling by two surface scatterers. Described herein is an innovative replacement of one of the scatterers by a fiber-based reflective component, which remotely influences the mode coupling of the EP resonator. The reflective component does not only work as a “remote scatterer” to steer the system around EPs, but also sends the phase change in response to external perturbations back to the EP resonator. Based on the spatial separation between the EP resonator and the sensor, the system described herein is divided into control unit 102 and sensing unit 104 (each shown in FIG. 1A). Microtoroid resonator 106 of control unit 104 may include an on-chip microtoroid resonator with two (e.g., tapered) fibers 110 (e.g., WG1 (112) and WG2 (114)) coupled and a fiber-based phase shifter (e.g., 116). WG1 (112) functions as a bus waveguide to input the light and to monitor the spectral characteristics. As shown in FIGS. 1A and 1B, two propagation modes supported by resonator 106, clockwise (CW) and counterclockwise (CCW) modes, are coupled by bidirectional coupling channel (e.g., 132 of WG2 (114) due to scatterer 108 and unidirectional coupling channel 134 of WG2 (114). The bidirectional coupling Ã(=Ae^{ia}) is realized by Rayleigh scatterer 108 on the surface of microtoroid resonator 106. The coefficient a is determined by the intrinsic frequency splitting (2A|cos α|/2π) and linewidth difference (4A|sin α|/2π) induced by Rayleigh scatterer 100. The surface defect or deformation formed in the fabrication as the intrinsic scatterer is exploited. On the other hand, one end of WG2 (114) is engineered without reflection (e.g., “Reflectionless end” 122 as shown in FIG. 1A), while the other end 124 connects to sensing unit 104 through (e.g., fiber-based) phase shifter 116. This introduces the unidirectional coupling \tilde{μ}(=μe^{iφ}) to microtoroid resonator 106. The coupling strength μ is affected by the distance between the tapered fiber and the resonator, as well as the reflectivity of sensing unit 104. The coupling phase o is the sum of the phase offset φ₀ controlled by the phase shifter and the phase perturbation Δφ of the sensing unit. The coupling channels between the CW and CCW modes give rise to the mode non-degeneracy, e.g., the bifurcation of two eigenstates (shown in FIG. 1C). The eigenvalues are given by

$${σ}_{\pm } = \pm \sqrt{\tilde{A} [ \tilde{A} + μexp i ( {φ}_{0} + Δφ ) ] ,}$$

and the bifurcation in response to phase perturbation Δφ reaches the maximum at EPs where the two eigenstates coalesce. The EPs are realized through carefully tuning the parameters into the destructive interference (μ=A and φ₀=α+π) to cancel one of the coupling directions (here CW-to-CCW). The real and imaginary parts of eigenvalues σ_{±} are exhibited by the topology of the surfaces shown in FIGS. 1D and 1E, representing the frequency splitting (2|Re(+_{±})|/2T) and linewidth difference (4|1m(σ_{±})|/2π) between two eigenmodes, respectively. At an EP, both of them are zero (marked by purple points) because of the coalescence of eigenstates.

As described herein, sensing unit 104 can be any optical sensor that has a phase change as being perturbed, including WGM microresonators, Fabry-Pérot resonators (FPRs), photonic crystals (PhCs), and even non-resonant fiber sensors. Conventional optical sensors for various applications can be easily compatible with platform 100 described herein. At EPs, the phase perturbation Δφ ≠0 leads to the recovery of the cancelled coupling direction and a drastic change of spectral characteristics, e.g., frequency splitting. The splitting can be measured from the transmission spectrum of the control unit by WG1 (112). The changes of splitting induced by subtle perturbations around EPs are larger than those of non-EPs (μ≠A).

### Results

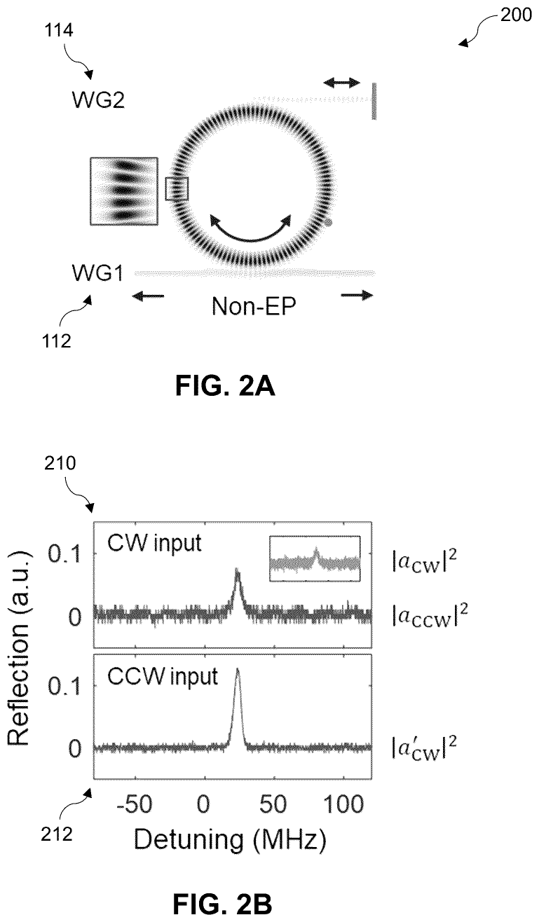

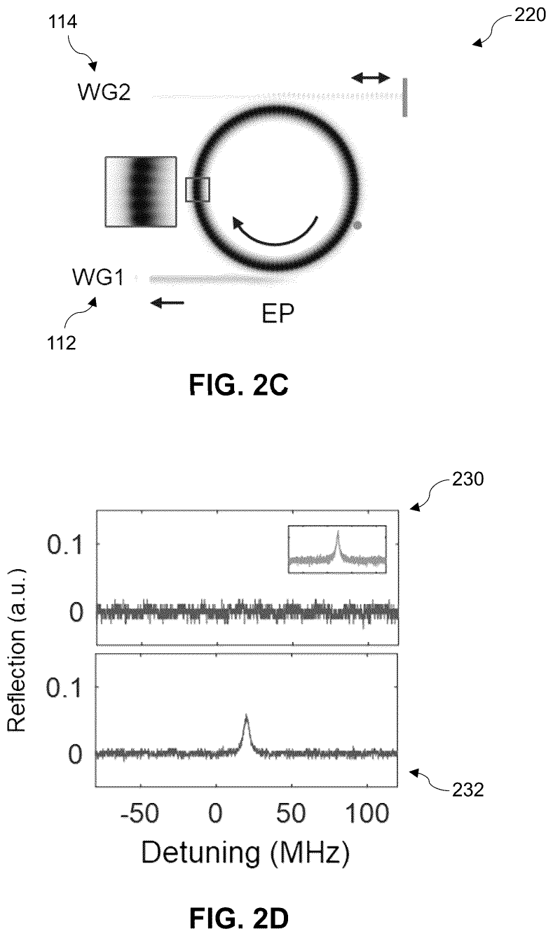

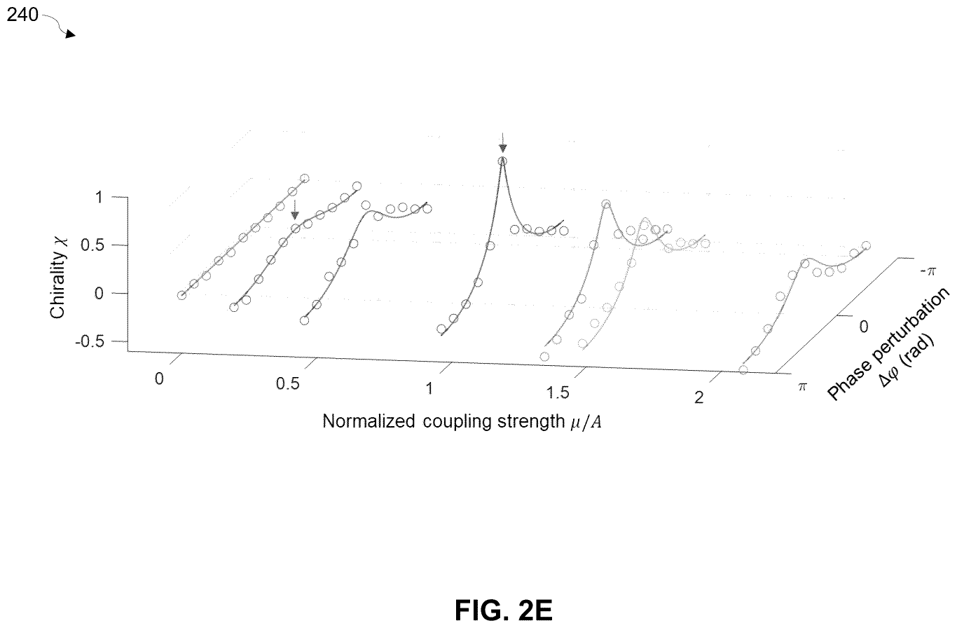

FIGS. 2A-2E illustrate one approach to an EP according to one embodiment of the present disclosure. Namely, to approach an EP by tuning the “remote scatterer.” More specifically, FIGS. 2A-2E illustrate a finite-element simulation of eigenmodes and experimental results of chiral properties.

FIG. 2A illustrates diagram 200 of platform 100 at a non-EP state that supports both CW and CCW travelling modes in resonator 106, and the simulated intracavity field pattern shows a standing wave solution. FIG. 2B illustrates plot 210 for the CW mode and plot 212 for the CCW mode. Since none of the coupling channels has not been cancelled, the intensities of CW and CCW modes,

$${\vert {a}_{CW}^{( ′ )} \vert}^{2} and {\vert {a}_{CCW} \vert}^{2} ,$$

are not zero regardless of the input mode. FIG. 2C illustrates diagram 220 of platform 100 at an EP state that only has one eigenmode (e.g., CW mode), and the simulation implies a pure travelling wave solution. The cancelled coupling channel blocks the excitation of the CCW mode as inputting the CW mode. FIG. 2D illustrates plot 230 for the CW mode and plot 232 for the CCW mode. FIG. 2E illustrates plot 240 of measurements of the chirality when tuning the coupling strength and phase perturbation as described in more detail herein. The chirality at EPs tends to the unity. The two arrows shown in FIG. 2E label the cases corresponding to FIG. 2B and FIG. 2D, respectively.

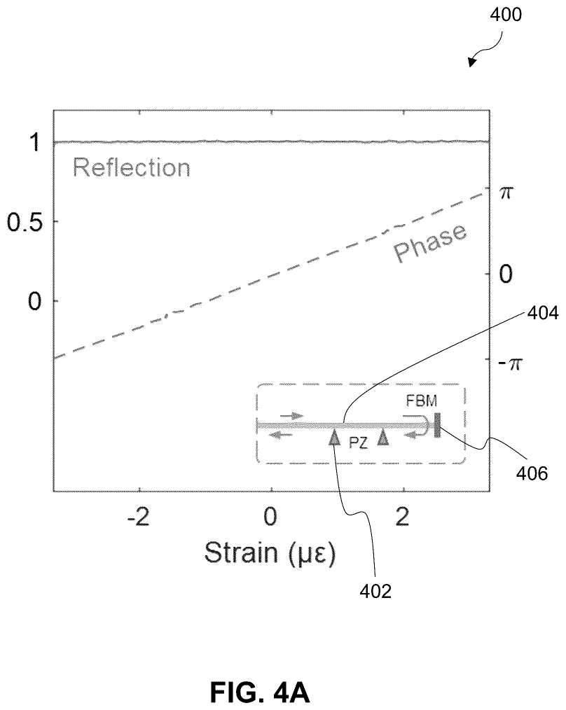

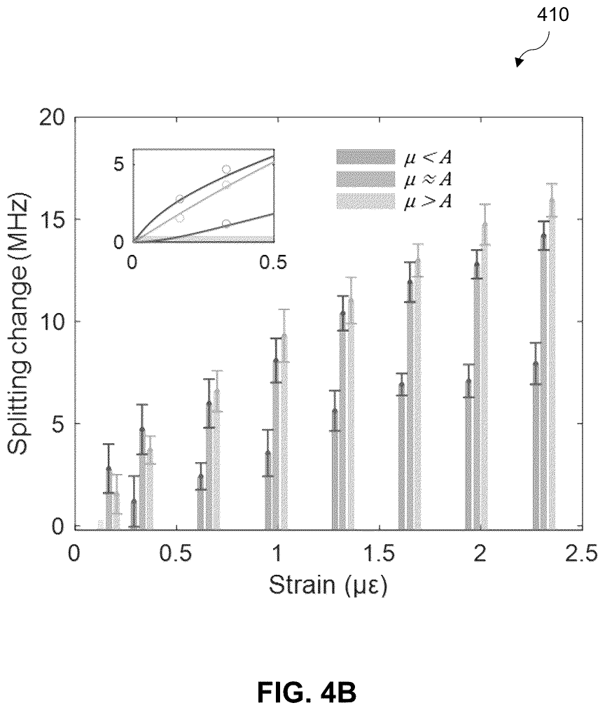

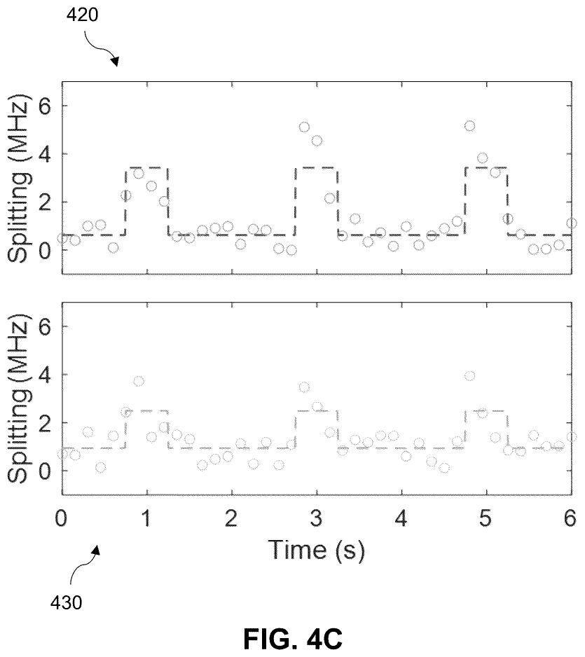

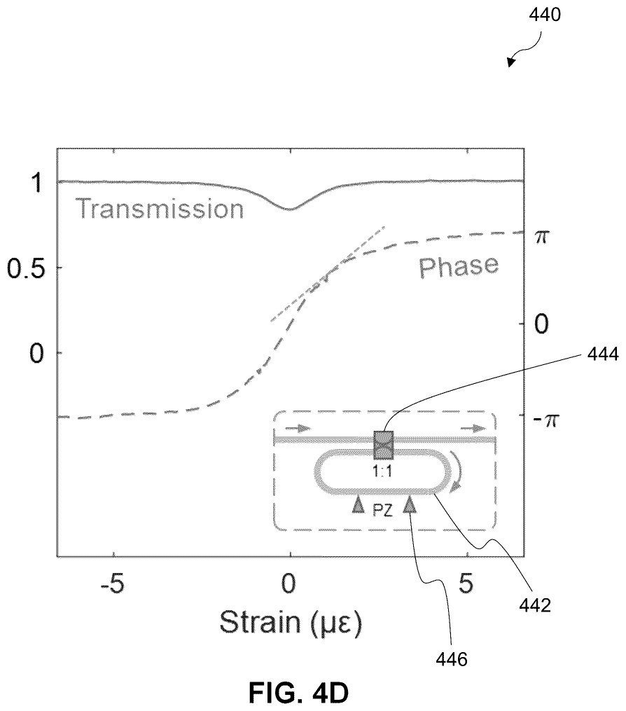

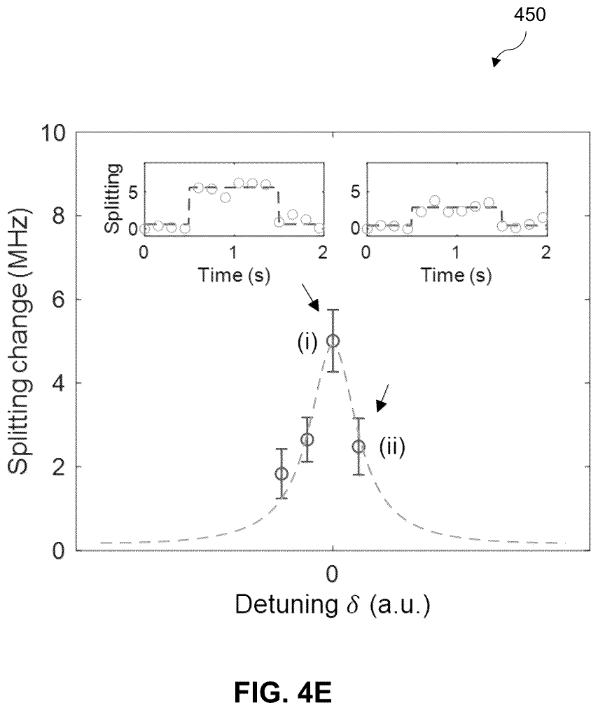

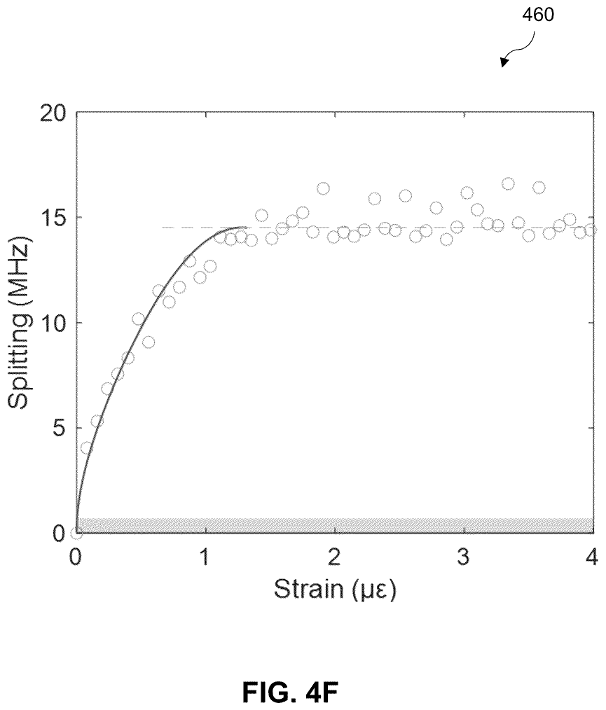

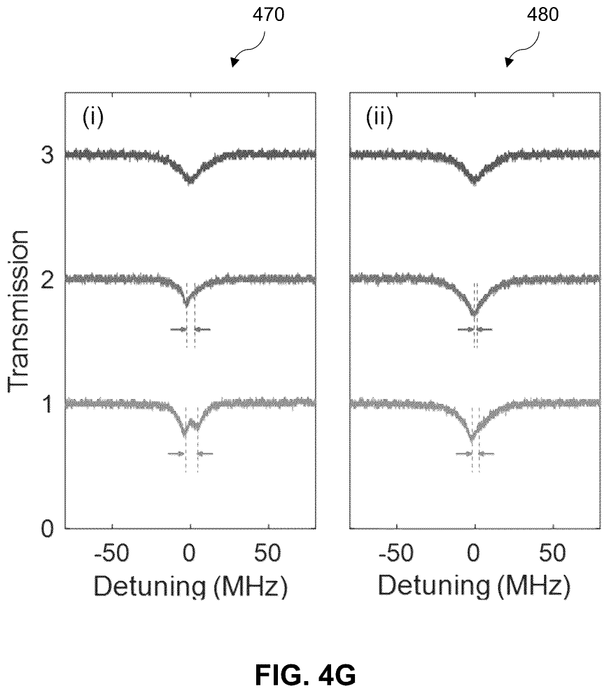

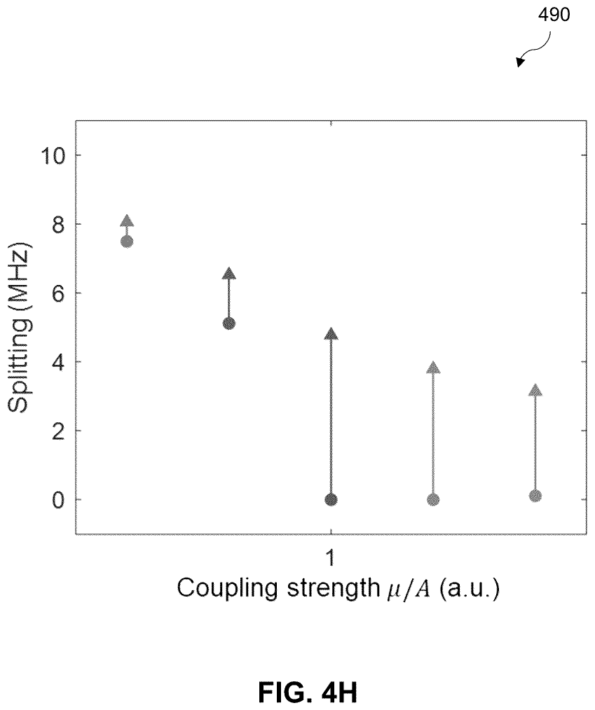

The unidirectional coupling and mode coalescence are the features of EP states. Investigation of the experimental criterion for finding and confirming EPs is described below. The system is steered in parameter space by tuning the coupling strength μ and phase φ, equivalent to the size and relative position of “remote scatterer,” respectively. Verification of the eigenmodes by a two-dimensional finite-element simulation (as shown in FIGS. 2A and 2C) was performed, in which the coupling channels (e.g., 132, 134) of microtoroid resonator 106 are realized by a nanoparticle with a designated diameter, such as a diameter of 100 nm and a unidirectional waveguide such as WG2 (114). A material layer such as a silver layer with a designated thickness such as a thickness of 100 nm coated on one end 122 of WG2 (114) is modeled as a reflector, while the other end 124 of WG2 (114) extends to a perfectly matched layer for minimizing the reflection. WG1 (112) is used to extract the propagation directions of modes. At a non-EP state, both the CW and CCW modes exist in microtoroid resonator 106. The overlapping of two modes results in a standing wave solution of the simulated intracavity field (as shown in FIG. 2A). In experiments, sensing unit 104 may be replaced with a fiber-based mirror (FBM) (shown in FIG. 4A) and introduce phase perturbations Δφ by phase shifter 116. As shown in FIG. 2B, none of the coupling directions is completely cancelled at the non-EP, and thus the CCW (CW) modes with the CW (CCW) input direction are not vanished

$$( {\vert {a}_{C C W} \vert}^{2} \neq 0 , {\vert {a}_{CW}^{′} \vert}^{2} \neq 0 ) .$$

As platform 100 is tuned to an EP, platform 100 only supports a travelling wave—the CW-direction mode—as its eigenmode. The blurred field pattern indicates a nearly pure travelling wave solution (as shown in FIG. 2C). Due to the cancelled coupling direction (CW-to-CCW), the intensity of the CCW mode is zero (|α_{CCW}|²=0) with CW input, while the CW mode with CCW input is still not vanished (|α′_{CW}|²≠0) (as shown in FIG. 2D). The measurements indicate that the criterion of EP states is the vanished reflection, which is useful in finding and confirming EPs in sensing experiments such as those described herein.

The asymmetric coupling—e.g., where one of the coupling directions is partially or completely cancelled—results in a non-zero chirality. The chirality is an intrinsic property only relying on the coupling symmetry and independent of the input field (as described in the “Methods” section herein). Sweeping of the coupling strength μ and phase Δφ, and recording of the reflection spectra

$$( {\vert {a}_{CCW} \vert}^{2} , {\vert {a}_{CW}^{′} \vert}^{2} ) .$$

with different input directions was performed. The non-zero chirality χoccurs because of the asymmetric coupling (μ/A≠0), and especially at an EP, it tends to the unity (as shown in FIG. 2E). The symmetric coupling at the case of μ/A=0 gives a zero chirality.

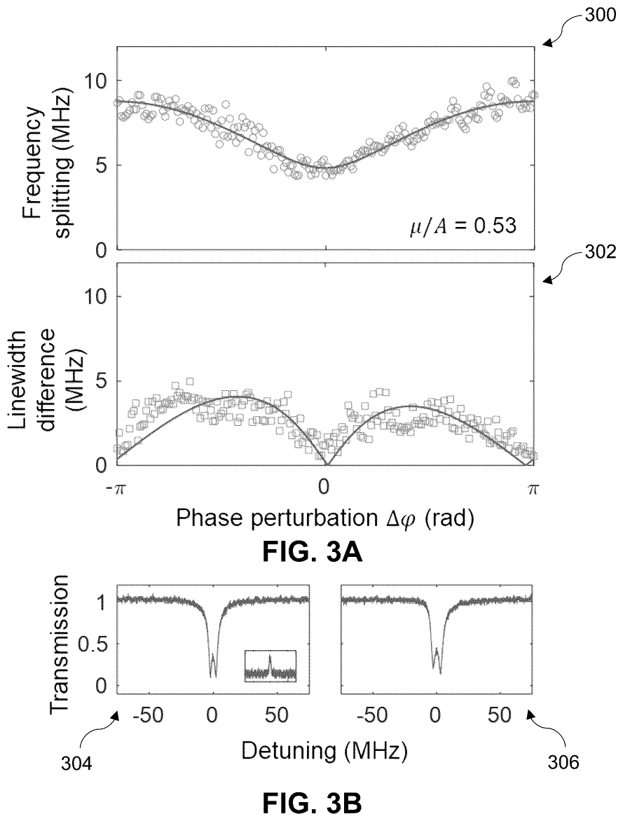

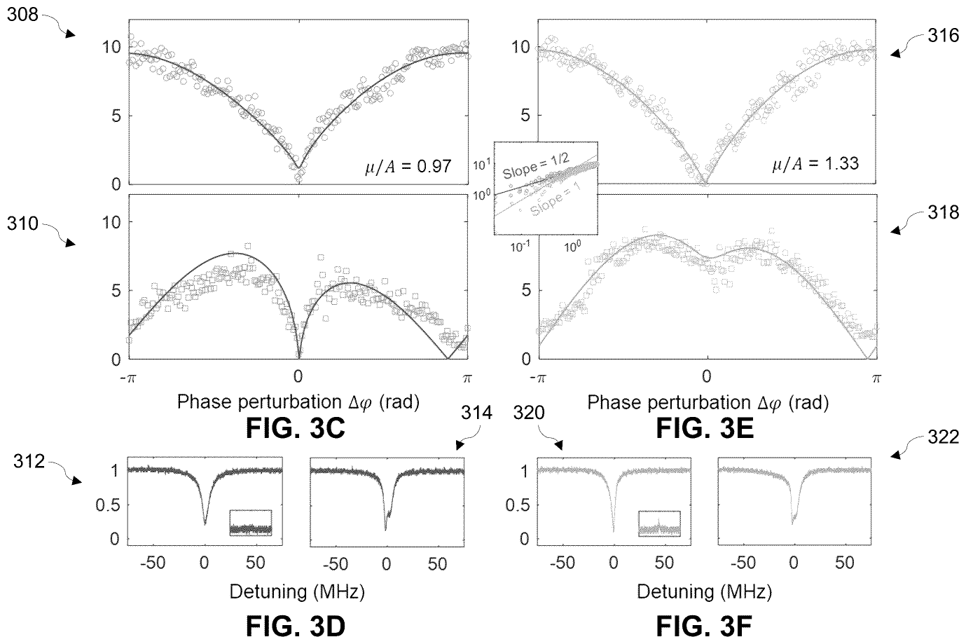

FIGS. 3A-3F illustrate responses of spectral characteristics of an EP according to one embodiment of the present disclosure. That is, the spectral responses to phase perturbations are characterized.

FIG. 3A illustrates plot 300 for frequency splitting and plot 302 for linewidth difference for a first coupling regime (e.g., μ/A=0.53). FIG. 3B illustrates plots 304 and 306 for transmission spectra at Δφ=0 (e.g., left plot 304) and Δφ=0.5 (e.g., right plot 306). FIG. 3C illustrates plot 308 for frequency splitting and plot 310 for linewidth difference for a second coupling regime (e.g., μ/A=0.97). FIG. 3D illustrates plots 312 and 314 for transmission spectra at Δφ=0 (e.g., left plot 312) and Δφ=0.5 (e.g., right plot 314). FIG. 3E illustrates plot 316 for frequency splitting and plot 318 for linewidth difference for a third coupling regime (e.g., μ/A=1.33). FIG. 3F illustrates plots 320 and 322 for transmission spectra at Δφ=0 (e.g., left plot 320) and Δφ=0.5 (e.g., right plot 322). While not shown in FIGS. 3C and 3E, the y-axes of the plots shown in FIGS. 3C and 3E are labelled the same as those in FIG. 3A (e.g., “Frequency splitting (MHz)” for the top plots 308, 316, same as in plot 300, and “Linewidth difference (MHz)” for the bottom plots 310, 318, same as in plot 302). While not shown in FIGS. 3D and 3F, the y-axes of the plots shown in FIGS. 3D and 3F are labelled the same as that in FIG. 3B (e.g., “Transmission”).

For FIGS. 3A, 3C, and 3E, the frequency splitting and the linewidth difference as varying the phase perturbation Δφ at three coupling regimes u/A (e.g., 0.53, 0.97, 1.33). The EP state nearly exhibits a zero reflection (e.g., inset of FIG. 3D), zero frequency splitting and zero linewidth difference. The insets of the figures display a logarithmic plot of frequency splitting in the cases of FIG. 3C and FIG. 3E. The small perturbations induce a square-root relation at the EP case and a linear relation at the non-EP case, while they tend to be the same at larger perturbations. The solid lines are fitting results. For FIGS. 3B, 3D, and 3F, the transmission spectra include Δφ=0 (left plots 304, 312, 320) and Δφ=0.5 (right plots 306, 314, 322). The changes of splitting at the EP are larger than the other two non-EP states. The inset is the reflection spectra at Δφ=0.

The optical phase perturbation from sensing unit 104 brings about the changes of spectral characteristics, including frequency splitting and linewidth difference. Ahead of measuring with an actual optical sensor, investigations of the spectral response of platform 100 by an electrical-controlled phase shifter (e.g., 116) to mimic the phase change induced by sensing targets were conducted. Note that the change of splitting as perturbed by small phase can be obscured by broader linewidth in spectra due to the coupling dissipation (as described in “Methods”). To recognize the tiny spectral changes, an erbium-doped silicon dioxide (silica) microtoroid was selected as microtoroid resonator 106 of control unit 102 setting platform 100 near or away from EPs, although other types are envisioned. In this example, pump laser 172 includes a 1460-nm band light and erbium ions pumped by the 1460-nm band light provide the optical gain to compensate losses at a 1550-nm band to help resolve small splitting. Fabrication procedures with the doping concentration of 2×10¹⁹ cm⁻³ were performed. Adjustment of the coupling strength of WG1 (112) as well as the power of the probe light (<10 μW) (e.g., of probe laser 184) at 1550-band was performed. The erbium-doped microtoroid with the optimal status retains enough optical gain but below the lasing threshold for resolving the splitting, and without any Fano-like lineshape that disturbs the curve fitting.

However, the low probe power may lead to mistaking an inexact EP state. A non-EP state, slightly off an EP, can also exhibit a “zero” reflection since the weak reflection intensity is overwhelmed by the shot noise. Thus, before reducing the probe power to the optimal value for spectral characterization, the EPs are found and confirmed at a stronger probe power.

The frequency splitting and linewidth difference are fitted from the transmission spectra the phase perturbation Δφ is tuned in the cases of μ<A, μ≈A, and μ>A (as shown in FIGS. 3A, 3C, 3E). At the EP, both of them are nearly zero due to the mode coalescence. The values of μ/A are obtained by fitting the frequency splitting according to the theoretical formula of Re (σ_{±}), and the solid lines are plotted by the fitted parameters. The logarithmic inset of frequency splitting shows the square-root relation for small perturbations at μ≈A and the linear relation at μ>A. The relations in the two cases tend to be the same as the perturbation increases. FIGS. 3B, 3D, and 3F demonstrate the transmission spectra changing from Δφ=0 to Δφ=0.5 at the three cases of μ/A, respectively. The change of frequency splitting at the EP is more significant than those at the other two non-EPs. Based on that, the sensitivity of an optical sensor is expected to be improved by connecting it as a sensing unit and tuning the platform into EPs.

FIGS. 4A-4H illustrate aspects of strain sensing according to one embodiment of the present disclosure. More specifically, FIGS. 4A-4H illustrate EP-enhanced fiber strain sensing.

FIG. 4A illustrates a plot 400 of a reflection-type non-resonant strain sensor. A piezo (PZ) component 402 stretches a fiber 404 (e.g., such as WG2 114) to introduce optical phase change, and an FBM 406 reflects the light to the microresonator (e.g., such as microtoroid resonator 106). The light (e.g., originally from a laser such as laser 184 shown in FIG. 1F) goes through the stretched part two times.

FIG. 4B illustrates plot 410 showing the changes of frequency splitting as applying the pulsed strains in the cases of μ<A, μ≈A, and μ>A, namely μ/A=0.83, 1.05, 1.47, respectively. The inset of FIG. 4B displays the fitted solid curves at smaller perturbations. The shading area represents the fluctuation of the splitting at an EP.

FIG. 4C illustrates plots 420 and 430 showing aspects of frequency splitting in response to the pulsed strains (e.g., amplitude 0.165με) applied to the systems at μ≈A (plot 420) and μ>A (plot 430).

FIG. 4D illustrates plot 440 showing aspects of a transmission-type resonant strain sensor. A fiber ring resonator 442 is formed by connecting the ports of a 1:1 fiber splitter 444 end to end. Stretching may be implemented by one or more PZs 446. The light with phase change is sent back to the control unit (e.g., such as control unit 102 shown in FIGS. 1A and 1F) with the help of an optical circulator (not shown).

FIG. 4E illustrates plot 450 showing the changes of frequency splitting as applying the pulsed strains (amplitude 0.158με) at different detuning δ between the EP resonator (e.g., as shown in FIG. 4A) and the fiber ring sensor (e.g., as shown in FIG. 4D). The dashed line is the magnitude of the slope of the phase curve in FIG. 4D. The insets of FIG. 4E illustrate additional splitting plots.

FIG. 4F illustrates plot 460 showing aspects of frequency splitting with the strains increasing. The fluctuation of the frequency splitting is labelled by the shading area.

FIG. 4G illustrates plots 470 and 480 showing aspects of the transmission spectra as applying the stronger strains (e.g., from top to bottom), corresponding to the states of (i) zero (plot 470) and (ii) non-zero (plot 480) detuning such as shown in FIG. 4E.

FIG. 4H illustrates plot 490 showing aspects of the changes of frequency splitting as applying the pulsed strains at different coupling strengths. The maximum response occurs at the EP state μ/A≈1. The x-axis label “a.u.” in FIGS. 4E and 4H is arbitrary units.

At EPs, the sensing platform (e.g., 100) described herein amplifies the frequency splitting induced by the phase change of a conventional optical sensor. To demonstrate the universality of EP enhancement for sensitivity, the fiber strain was chosen as the detected target, because of its simple and linear relation to the optical phase. A variety of fiber-based optical strain sensors, such as fiber Bragg grating, in-line interferometer, and distributed fiber strain sensor, have been investigated and extensively used in precise measurement and structural health monitoring due to their high sensitivity, lightweight size, and resistance to electromagnetic interference. Results indicate the minimum detectable strain is limited by ˜0.02με. In demonstration, two types of fiber strain sensors were constructed, reflection-type non-resonant sensor (as shown in FIG. 4A) and transmission-type resonant sensor (as shown in FIG. 4D).

In the first sensor, a reflection-type non-resonant sensor (shown in FIG. 4A), the strain is introduced by a PZ component (e.g., 402) stretching an 8-cm-long fiber (e.g., 404). The light is reflected to the control unit (e.g., 102 shown in FIGS. 1A and 1F), going through the stretched fiber twice and accumulating a total phase change Δφ. The fiber length between the control unit (e.g., 102 shown in FIGS. 1A and 1F) and sensing unit (e.g., 104 shown in FIGS. 1A and 1F) is about 3 meters to simulate remote sensing. The phase shifter (e.g., 116 shown in FIGS. 1A and 1F) is modulated by a triangle waveform for the compensation of the additional phase change induced by the frequency scanning (as described in “Methods” herein).

The pulsed strains (e.g., with period: 2 seconds, duty cycle: 25%) are applied with different amplitudes to the fiber, and the transmission spectra recorded at 0.15-second intervals.

The changes of frequency splitting at three cases of μ/A=0.83, 1.05, 1.47 are plotted in FIG. 4B. The EP enhancement is more significant for the small perturbations, e.g., <0.5με. The shading area in the inset represents the fluctuation of splitting at EPs at a certain frequency such as 0.404 MHz, which is the standard deviation of the splitting at the EP in FIG. 4C. The frequency splitting in response to the strain pulses with the amplitude of 0.165με is shown in FIG. 4C for the cases of μ≈A (plot 420) and μ>A (plot 430), respectively. The detection limit is defined as the strain that induces the signal (frequency splitting) equal to the fluctuation, e.g., signal-to-noise ratio (SNR)=1. Thus, the detection limit at the EP is derived as 0.0173με, which is enhanced by 10.3 and 2.1 times from the other two non-EP cases described herein, respectively. As a comparison, the sole sensor is characterized by an MZI. The noise is dominated by the shot noise if inputting the probe light with the same power (2.5 μW). The detection limit of the sole sensor is derived as 0.0568με. The apple-to-apple enhancement of EP sensing platform is 3.3 times for the reflection-type non-resonant strain sensor (shown in FIG. 4A).

The second strain sensor, a transmission-type resonant sensor (shown in FIG. 4D), is built from a fiber ring resonator (e.g., 442, as shown in FIG. 4D). The two interlinked ports of a 1:1 fiber splitter (e.g., 444) are connected enabling optical resonance. The perimeter of the ring is about 0.56 meters, and the stretched length for introducing strains is the same as that of the first sensor (8 cm). This sensor works at the overcoupling regime to diminish the transmission variation (˜17%), otherwise it leads to the drastic change of coupling strength μ, which can deviate the system from EPs and degrade the sensing performance. The transmitted light with the phase change is sent back to the control unit (e.g., 102 shown in FIGS. 1A and 1F) through an optical circulator (not shown).

In experiments, for the maximum response to strain perturbations, the resonance of the fiber ring sensor shown in FIG. 4D needs to be matched with that of the EP resonator. At their different detuning δ, measurement of the splitting changes (as shown in FIG. 4E), in which the amplitude of strain pulses keeps as 0.158με, was performed. For each detuning point, the system is tuned to the EP that is confirmed by zero reflection. Note that the maximum change occurs at the matching point ((i), δ=0), where the slope of the phase curve of the sensor is the sharpest. The two panels (e.g., plots 470 and 480) of FIG. 4G, corresponding to the detuning points (i) and (ii), respectively, exhibit the transmission spectra with the perturbed strains increasing (from top to bottom, 0με, 0.189με, 0.461με). Next, study of the behavior of the frequency splitting around an EP as the strains increase (as shown in FIG. 4F) was performed. The change of splitting is sensitive to the small strain perturbations, and then saturated due to the smooth phase curve off resonance. The shading area represents the fluctuation of splitting at EPs at a certain frequency such as 0.746 MHz, larger than that of the non-resonant sensor. The detection limit is 0.00430με at the EP, derived from the solid curve that is fitted from the first few points. Compared with the measurements by an MZI, the EP platform (e.g., 100) described herein provides the enhancement factor 5.9 for the transmission-type resonant sensor shown in FIG. 4D. Finally, the changes of frequency splitting are shown in FIG. 4H as the system is tuned to an EP by varying the coupling strength. The maximum response occurs at an EP (μ/A≈1).

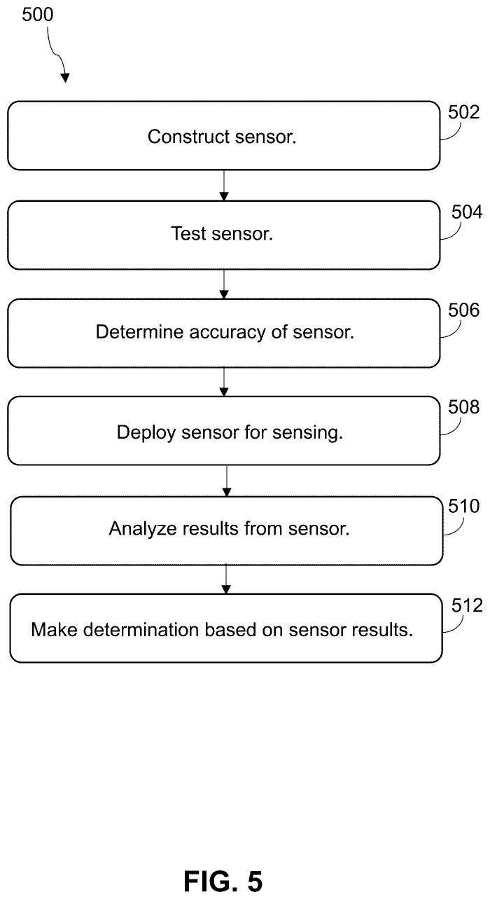

FIG. 5 is a flow diagram of an example method 500 according to one embodiment of the disclosure. Step 502 of method 500 includes constructing a sensor, including EP-enhanced construction such as via platform 100 as disclosed herein. Step 504 of method 500 includes testing the sensor, including testing as disclosed herein (e.g., as shown in FIG. 1F). Step 506 of method 500 includes determining an accuracy of the sensor, for example for use in displacement detection or other applications as described herein. Step 508 of method 500 includes deploying a sensor deemed suitable in an appropriate sensing environment as described herein. Step 510 of method 500 includes analyzing results from the deployed sensor, such as displacement measurements and/or other sensing measurements as described herein. Step 512 of method 500 includes making determinations based on the sensor results, as described herein (e.g., determinations for perturbations, etc., across any applicable industry or technology utilizing the sensor).

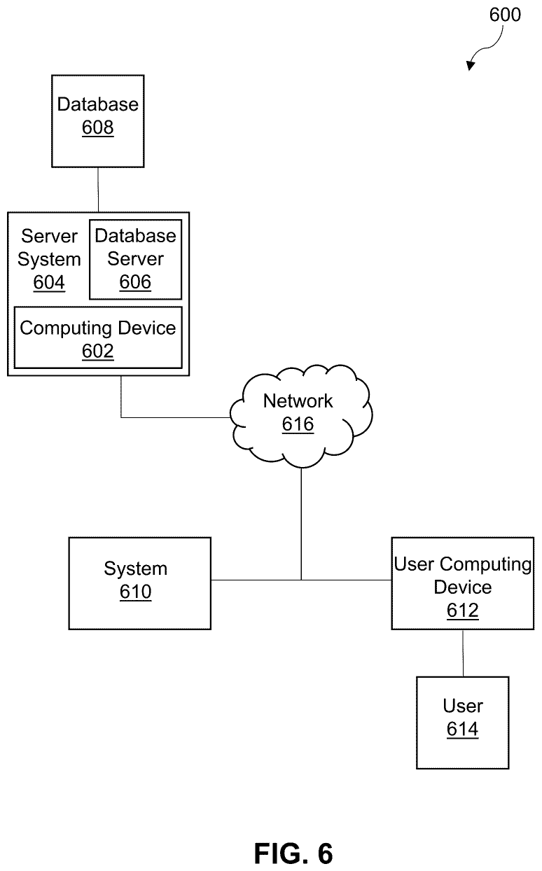

FIG. 6 is a block diagram schematically illustrating a computing system in accordance with one aspect of the disclosure. FIG. 6 illustrates a simplified block diagram of a computing system 600 for implementing the methods described herein. As illustrated in FIG. 6, the computing system 600 may be configured to implement at least a portion of the tasks associated with disclosed method using the disclosed sensors (e.g., EP-enhanced sensors, such as for displacement sensing or other sensing applications as described herein). Computer system 600 may include a computing device 602 that may be the same as or similar to computer device 194 shown in FIG. 1F. In one aspect, computing device 602 is part of a server system 604, which also includes a database server 606. Computing device 602 is in communication with a database 608 through database server 606. Database 608 may be configured to store information such as test results and the like as described herein. Computing device 602 is in operative communication with system 610 (e.g., a sensing system) that may be the same as or similar to platform 100 shown in FIG. 1A and a user computing device 612 of a user 614 through a network 616. User computing device 612 may be utilized by user 614 to view/analyze results of the various tests and/or experiments described herein. Network 616 may be any network that allows local area or wide area communication between the devices. For example, network 616 may allow communicative coupling to the Internet through at least one of many interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and a cable modem. User computing device 612 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In other aspects, computing device 602 is configured to perform a plurality of tasks associated with the operation of a sensor and/or a system incorporating the sensors described herein including, but not limited to the displacement systems and other applications using the sensors as described herein.

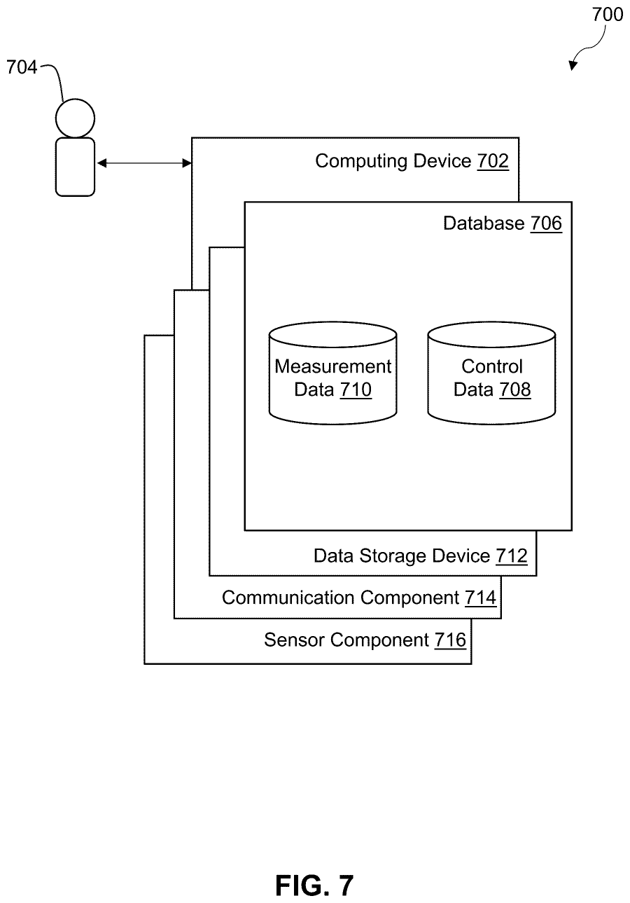

FIG. 7 depicts a component configuration 700 of computing device 702 associated with a user 704. In some aspects, computing device 702 may be the same as or similar to computing device 602 shown in FIG. 6 and user 704 may be the same as or similar to user 614 shown in FIG. 6. User 704 may access components of computing device 702. For example, user 704 may be a technician running a test using platform 100 shown in FIG. 1A and/or setup 170 shown in FIG. 1F. Computing device 702 includes database 706 along with other related computing components. In some aspects, database 706 may be the same as or similar to database 608 shown in FIG. 6.

In one aspect, database 706 includes control data 708 and measurement data 710. Non-limiting examples of control data 708 may include control parameters for the various components included in platform 100 and/or setup 170, such as controls to control laser power. Additional non-limiting examples of suitable control data 708 include any algorithms and any values of parameters defining the algorithms associated with the disclosed methods as described herein. Non-limiting examples of measurement data 710 include measurement results from sensors subjected to testing and/or experimentation.

Computing device 702 also includes a number of components that perform specific tasks. In the example aspect, computing device 702 includes data storage device 712, communication component 714, and sensor component 716. Data storage device 712 is configured to store data received or generated by computing device 702, such as any of the data stored in database 706 or any outputs of processes implemented by any component of computing device 702. Communication component 714 is configured to enable communications between computing device 702 and other devices (e.g., user computing device 612 and system 610, shown in FIG. 6) over a network, such as network 616 (shown in FIG. 6), or a plurality of network connections using predefined network protocols such as TCP/IP (Transmission Control Protocol/Internet Protocol). Sensor component 716 is configured to control aspects relating to the sensors described herein, including but not limited to design, testing, and/or fabrication parameters. Components 712-716 may be a combination of software modules and/or corresponding hardware components, which in some aspects may be dedicated hardware components such as dedicated processors and the like.

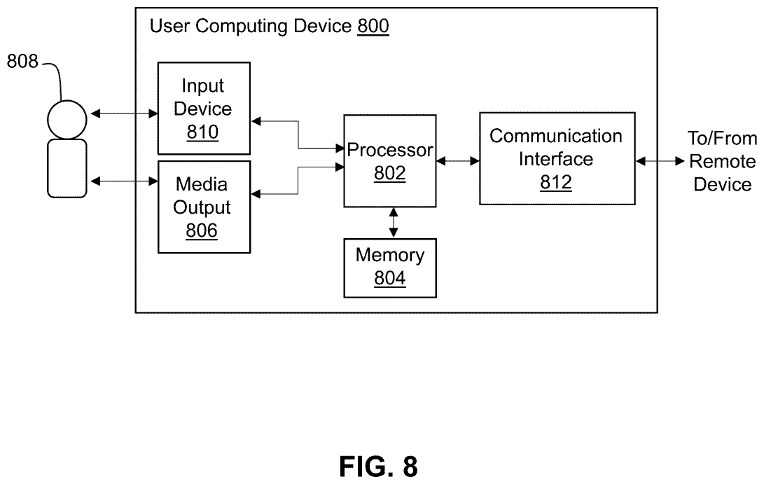

FIG. 8 depicts a configuration of a remote or user computing device 800, such as user computing device 612 (shown in FIG. 6). Computing device 800 may include a processor 802 for executing computer-readable/-executable instructions. In some aspects, executable instructions may be stored in a memory area of memory 804. Processor 802 may include one or more processing units (e.g., in a multi-core and/or parallel configuration). Memory 804 may be any device allowing information such as executable instructions and/or other data to be stored and retrieved. Memory 804 may include one or more computer-readable media (e.g., hard drive, RAM, ROM, and the like).

Computing device 800 may also include at least one media output component 806 for presenting information to a user 808. Media output component 806 may be any component capable of conveying information to a user 808. In some aspects, media output component 806 may include an output adapter, such as a video adapter and/or an audio adapter. An output adapter may be operatively coupled to processor 802 and operatively coupled to an output device such as a display device (e.g., a liquid crystal display (LCD), organic light emitting diode (OLED) display, cathode ray tube (CRT), or “electronic ink” display) or an audio output device (e.g., a speaker or headphones). In some aspects, media output component 806 may be configured to present an interactive user interface (e.g., a web browser or client application) to user 808.

In some aspects, computing device 800 may include an input device 810 for receiving input from user 808. Input device 810 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 806 and input device 810.

Computing device 800 may also include a communication interface 812, which may be communicatively coupled to a remote device. Communication interface 812 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory 804 are, for example, computer-readable/-executable instructions for providing a user interface to user 808 via media output component 806 and, optionally, receiving and processing input from input device 810. A user interface may include, among other possibilities, a web browser and client application. Web browsers enable users 808 to display and interact with media and other information typically embedded on a web page or a website from a web server. A client application allows users 808 to interact with a server application associated with, for example, a vendor or business.

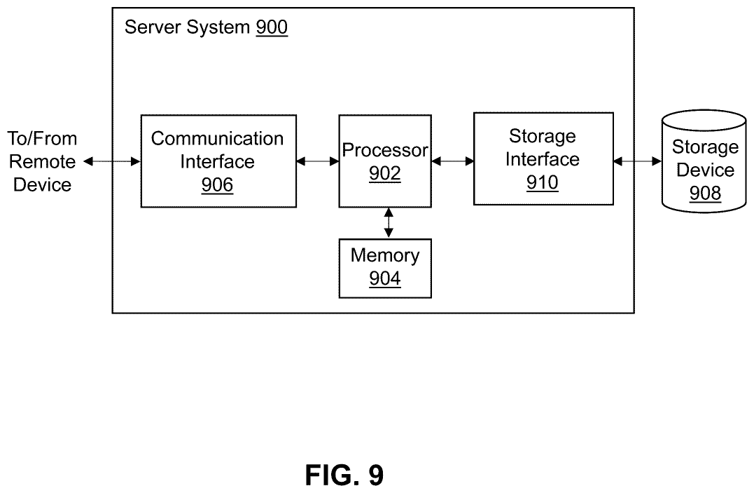

FIG. 9 illustrates an example configuration of a server system 900. Server system 900 may include, but is not limited to, database server 606 and computing device 602 (both shown in FIG. 6), computing device 702 shown in FIG. 7, and/or computer device 194 shown in FIG. 1F. In some aspects, server system 900 is the same as or similar to server system 604 (shown in FIG. 6). Server system 900 may include a processor 902 for executing instructions. Instructions may be stored in a memory area of memory 904, for example. Processor 902 may include one or more processing units (e.g., in a multi-core or parallel configuration).

Processor 902 may be operatively coupled to a communication interface 906 such that server system 900 may be capable of communicating with a remote device such as user computing device 612 (shown in FIG. 6) or one or more other server systems 900. For example, communication interface 906 may receive requests from user computing device 612 via a network 616 (shown in FIG. 6).

Processor 902 may also be operatively coupled to a storage device 908. Storage device 908 may be any computer-operated hardware suitable for storing and/or retrieving data. In some aspects, storage device 908 may be integrated in server system 900. For example, server system 900 may include one or more hard disk drives as storage device 908. In other aspects, storage device 908 may be external to server system 900 and may be accessed by a plurality of server systems 900. For example, storage device 908 may include multiple storage units such as hard disks or solid state disks in a redundant array of inexpensive disks (RAID) configuration. Storage device 908 may include a storage area network (SAN) and/or a network attached storage (NAS) system.

In some aspects, processor 902 may be operatively coupled to storage device 908 via a storage interface 910. Storage interface 910 may be any component capable of providing processor 902 with access to storage device 908. Storage interface 910 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 902 with access to storage device 908.

Memory 804 (shown in FIGS. 8) and 904 may include, but are not limited to, non-transitory random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

### Methods

Described below are various methods utilized and/or otherwise implemented by/in the present disclosure.

Hamiltonian and coupled mode equations: In the travelling-wave basis (CW, CCW), the effective 2×2 Hamiltonian is written as

$$H = {ω}_{0} - i \frac{{Γ}_{0}}{2} + ( \begin{matrix}0 & \tilde{A} \\ \tilde{A} + \tilde{μ} & 0\end{matrix} )$$

with Ã=Ae^{ia}, μ=μe^{iφ}^{₀} , Γ₀=γ₀+κ₀+k−g, and μ=κr. Here, ω₀ is the resonant frequency of the microtoroid without coupling channels, and γ₀, κ₀, κ are the intrinsic loss, the coupling strength (loss) of the probe fiber, and the coupling strength (loss) of the fiber (e.g., 114) connected with the sensing unit (e.g., 102), respectively. The quantity g is the optical gain provided by erbium ions. The quantity r is the reflectivity of the sensing unit. The quantities Ã and \tilde{μ} are the complex bidirectional coupling strength and the complex unidirectional coupling strength as described in FIGS. 1A-1E. The splitting of the eigenmodes is solved as

$${σ}_{\pm } ≡ Ω ∓ i \frac{Γ}{2} = \pm \sqrt{\tilde{A} ( \tilde{A} + \tilde{μ} )}$$

As the parameters are tuned to μ=A and φ₀=aα+π, the coupling channel (Ã+\tilde{μ}) vanishes and the system (e.g., platform 100) is at an EP. If the phase perturbation is sufficiently small (Δφ«1), the approximated splitting at the EP exhibits a drastic change due to the square-root relation to Δφ,

$${σ}_{\pm } \approx \pm A {e}^{i ( α - π / 4 )} \sqrt{Δφ}$$

The linewidth needs to be narrow enough to observe the frequency splitting in transmission spectra, e.g., γ₀+κ₀+κ−g≲2Re (σ_{±}). The small phase perturbation gives σ_{±}+→0. Thus, the optical gain (g>0) is required in the experiments for the splitting characterization. With the CW-direction input (Sᵢₙ), the coupled mode equations can be written as

$$i \frac{d}{d t} {a}_{C W} = ( - Δ - i \frac{{Γ}_{0}}{2} ) {a}_{C W} + \tilde{A} {a}_{C C W} + \sqrt{{κ}_{0}} {s}_{i n}$$

$$i \frac{d}{d t} {a}_{CCW} = ( \tilde{A} + \tilde{μ} ) {a}_{CW} + ( - Δ - i \frac{{Γ}_{0}}{2} ) {a}_{CCW}$$

The expression of the transmission used for curve fitting is obtained from the stationary solution,

$$T = {\vert 1 + i {κ}_{0} \frac{- Δ - i {Γ}_{0} / 2}{( - Δ - i {Γ}_{0} / 2 + Ω - i Γ / 2 ) ( - Δ - i {Γ}_{0} / 2 - Ω + i Γ / 2 )} \vert}^{2}$$

Derivation of the chirality: The chirality x reveals the asymmetry of coupling channels, which can be characterized by the reflections as inputting the probe light from different directions,

$${R}_{CW input} = {\vert {κ}_{0} {a}_{C C W} \vert}^{2} = {\vert \frac{{κ}_{0} ( \tilde{A} + \tilde{μ} )}{{( Δ + i {Γ}_{0} / 2 )}^{2} - \tilde{A} ( \tilde{A} + \tilde{μ} )} \vert}^{2}$$

$${R}_{CCW input} = {\vert {κ}_{0} {a}_{C W} \vert}^{2} = {\vert \frac{{κ}_{0} \tilde{A}}{{( Δ + i {Γ}_{0} / 2 )}^{2} - \tilde{A} ( \tilde{A} + \tilde{μ} )} \vert}^{2}$$

The chirality is defined as

$$χ = \frac{\sqrt{{R}_{CCW input}} - \sqrt{{R}_{CW input}}}{\sqrt{{R}_{CCW input}} + \sqrt{{R}_{CW input}}} ≡ \frac{1 - B}{1 + B}$$

$$B = \sqrt{\frac{{R}_{CW input}}{{R}_{CCW input}}} = \sqrt{1 + 2 \frac{μ}{A} cos ( {φ}_{0} - α ) + {( \frac{μ}{A} )}^{2}}$$

The symmetric coupling (μ=0) gives the zero chirality, while at an EP, the complete cancellation of one coupling direction (u/A=1, φ₀=π+α) results in the chirality χ_{EP}=1. The solid lines in FIG. 2E, for example, are fitted from the expression of χ.

Compensation of additional phase changes induced by frequency scanning: In experiments, for monitoring the spectral characteristics (frequency splitting and linewidth difference), a triangle wave (60 Hz, 2 Vpp) was used to scan the output frequency ω(t) of the tunable laser. Noting the phase offset φ₀=ω(t)L/c, the phase change of the long fiber L due to the frequency scanning cannot be neglected. One possible phenomenon is the deformation of the transmission curve at the EP, because of the varying phase at different optical frequencies. Using a shorter fiber can reduce this effect (L<0.5 m for FIG. 3). For the longer fiber used in the remote sensing experiments, a 4.98-kHz triangle signal was applied to the phase shifter to compensate the frequency-related additional optical phase. Careful adjustment of the amplitude of the triangle wave (4.98 kHz), as well as its phase offset relative to the laser modulation signal (60 Hz), was performed. The derivation of EPs caused by frequency scanning is avoided.

For all of the above-described embodiments and usages, any code and/or data or other information may be stored in a memory of the above-described system, and/or in a remote (e.g., cloud) storage system (e.g., in a dedicated database or other centralized storage mechanism). Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

In operation, a computer executes computer-executable code/instructions embodied in one or more computer-executable components stored on one or more computer-readable media to implement aspects of the invention described and/or illustrated herein. Code can include application source code, application object code, configuration data, additional input events, application states, assertion statements, validation results, and/or any other type of data. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

The raw and/or processed data and/or any related graphical or other representations of the data may be processed by the above-described computer system or the like and output for display on a display device such as a TV, monitor, mobile device (e.g., mobile phone or tablet) and the like such that a technician/practitioner/evaluator/therapist/user can view and/or manipulate the data (e.g., the data may be presented in a visual format for presenting certain aspects of the test results, for example as shown in the applicable above-noted figures). For example, a display monitor may be connected (e.g., wired or wirelessly) to the above-described computer system to provide a visual output on the computer system. The computer system may have an operating system with a graphical user interface capable of being used by a user to (i) input, view, execute and/or manipulate the above-described computer code and/or (ii) process the obtained sensor data and any related graphical representations of such data in the manners described above. The operating system may be capable of running software applications such as those described above (e.g., MatLab and the like) for carrying out the above-described techniques and also any necessary post-processing and/or outputting of the obtained sensor data for viewing, such as for viewing by a therapist that is treating/diagnosing a patient/test subject. Additional software for other code/data manipulations and/or for generating other visuals relating to the data may also be present on the computer system.

In the present disclosure, all or part of the units or devices of any system and/or apparatus, and/or all or part of functional blocks in any block diagrams and flow charts may be executed by one or more electronic circuitries including a semiconductor device, a semiconductor integrated circuit (IC) (e.g., such as a processor), or a large-scale integration (LSI). The LSI or IC may be integrated into one chip and may be constituted through combination of two or more chips. For example, “processor” as used herein refers generally to any programmable system including systems and microcontrollers, reduced instruction set circuits (RISC), application specific integrated circuits (ASIC), programmable logic circuits (PLC), and any other circuit or processor capable of executing the functions described herein. The functional blocks other than a storage element may be integrated into one chip. The integrated circuitry that is called LSI or IC in the present disclosure is also called differently depending on the degree of integrations, and may be called a system LSI, VLSI (very large-scale integration), or ULSI (ultra large-scale integration). For an identical purpose, it is possible to use an FPGA (field programmable gate array) that is programmed after manufacture of the LSI, or a reconfigurable logic device that allows for reconfiguration of connections inside the LSI or setup of circuitry blocks inside the LSI. Furthermore, part or all of the functions or operations of units, devices or parts or all of devices can be executed by software processing (e.g., coding, algorithms, etc.). In this case, the software is recorded one or more non-transitory computer-readable recording media, such as one or more ROMs, RAMs (e.g., DRAM, SRAM), optical disks, hard disk drives, solid-state memory, servers, cloud storage, and so on and so forth, having stored thereon executable instructions which can be executed to carry out the desired processing functions and/or circuit operations. For example, when the software is executed by a processor, the software causes the processor and/or a peripheral device to execute a specific function within the software. The system/method/device of the present disclosure may include (i) one or more non-transitory computer-readable recording mediums that store the software, (ii) one or more processors (e.g., for executing the software or for providing other functionality), and (iii) a necessary hardware device (e.g., a hardware interface). Artificial intelligence in any and all types and formats may be utilized in any of the steps, techniques, protocols, analyses, and/or any other manipulation, generation, or other creation of data, results and/or any information described herein. This includes but is not limited to computer visions, machine learning, deep learning, neural networks, algorithms, and any data, models, and training needed for such. The above examples are example only, and thus are not intended to limit in any way the definitions and/or meanings of the terms.

Data conduits and any other communication or data transfer as described herein may include wired or wireless connections. For example, a wired network connection (e.g., Ethernet or an optical fiber), a wireless communication means, such as radio frequency (RF), e.g., FM radio and/or digital audio broadcasting, WiFi (e.g., IEEE 802.11 standards), WIMAX, a short-range wireless communication channel such as BLUETOOTH, a cellular phone technology (e.g., GSM), a satellite communication link, and/or any other suitable communication means. Such data conduits, in particular wired versions, can also be referred to as a system bus.

The embodiments were chosen and described in order to best explain the principles of the disclosure and its practical application to thereby enable others skilled in the art to best utilize the disclosure in various embodiments and with various modifications as are suited to the particular use contemplated. Aspects of the disclosed embodiments may be mixed to arrive at further embodiments within the scope of the invention.

As various modifications could be made in the constructions and methods herein described and illustrated without departing from the scope of the disclosure, it is intended that all matter contained in the foregoing description or shown in the accompanying drawings shall be interpreted as illustrative rather than limiting. Thus, the breadth and scope of the present disclosure should not be limited by any of the above-described example embodiments, but should be defined only in accordance with the following claims appended hereto and their equivalents.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects describe in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “example” is used herein to mean serving as an example, instance, or illustration. Any embodiment, implementation, process, feature, etc. described herein as example should therefore be understood to be an illustrative example and should not be understood to be a preferred or advantageous example unless otherwise indicated.

It should be noted that, as used herein, the term “couple” is not limited to a direct mechanical, electrical, and/or communication connection between components, but may also include an indirect mechanical, electrical, and/or communication connection between multiple components.

Having thus described several aspects of at least one embodiment, it is to be appreciated that various alternations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A phase sensing platform comprising one or more optical sensors with exceptional points (EPs) enhancement of sensitivity, the phase sensing platform comprising:
a sensor configured as an exception-point (EP)-enhanced sensor;
one or optical fibers associated with the EP-enhanced sensor;
a scatterer; and
a reflective component, wherein the reflective component is configured to influence a mode coupling of the EP-enhanced sensor.

2. The phase sensing platform of claim 1, further comprising a phase shifter, wherein at least one of the one or more optical fibers is configured as a waveguide, a first end of the waveguide is configured as a reflectionless end, and a second end of the waveguide opposite the first end is associated with the phase shifter.

3. The phase sensing platform of claim 1, wherein the reflective component is a fiber-based reflective component.

4. The phase sensing platform of claim 1, wherein the reflective component is configured as an optical sensor of the type: (i) reflection-type; (ii) transmission-type; (iii) non-resonant-type; or (iv) resonant-type.

5. The phase sensing platform of claim 1, wherein the reflective component is configured to steer around EPs and send a phase change in response to external perturbations back to the EP-enhanced sensor.

6. The phase sensing platform of claim 1, wherein the EP-enhanced sensor includes one of a whispering-gallery resonator, a photonic crystal, a Fabry-Perot cavity, or a fiber-based sensor.

7. The phase sensing platform of claim 1, further comprising a control unit operatively coupled to a sensing unit by an optical fiber of the one or more optical fibers, wherein the control unit is configured for tuning EP states and wherein the sensing unit is configured for detecting perturbations.

8. The phase sensing platform of claim 7, wherein the one or more optical fibers include two optical fibers, the control unit includes an on-chip resonator coupled with the two optical fibers and a phase shifter, and the sensing unit includes a remote sensor.

9. The phase sensing platform of claim 8, wherein the control unit and the sensor unit are detached and separated by meter-scale.

10. A method of enhancing sensitivity of one or more optical sensors with exceptional points (EPs), the method comprising:
providing a sensor configured as an exception-point (EP)-enhanced sensor;
providing one or optical fibers associated with the EP-enhanced sensor;
providing a scatterer; and
providing a reflective component, wherein the reflective component is configured to influence a mode coupling of the EP-enhanced sensor.

11. The method of claim 10, wherein the reflective component is a fiber-based reflective component.

12. The method of claim 10, wherein the reflective component is configured as an optical sensor of the type: (i) reflection-type; (ii) transmission-type; (iii) non-resonant-type; or (iv) resonant-type.

13. The method of claim 10, further comprising:
steering, via the reflective component, around EPs; and
sending a phase change in response to external perturbations back to the EP-enhanced sensor.

14. The method of claim 10, wherein the EP-enhanced sensor includes one of a whispering-gallery resonator, a photonic crystal, a Fabry-Perot cavity, or a fiber-based sensor.

15. The method of claim 10, further comprising:
providing a control unit;
providing a sensing unit; and
operatively coupling the control unit to the sensing unit by an optical fiber of the one or more optical fibers.

16. The method of claim 15, further comprising:
tuning for EP states via the control unit; and
detecting perturbations via the sensing unit.

17. The method of claim 16, wherein the control unit includes an on-chip resonator coupled with the one or more optical fibers and a phase shifter, and the sensing unit includes a remote sensor.

18. A method of enhancing sensitivity in a microresonator with exceptional points (EPs), the method comprising:
coupling one or more modes of the microresonator via a bidirectional coupling channel and a unidirectional coupling channel;
manipulating the mode coupling by a scatterer and a reflective component, wherein the reflective component is configured to influence the mode coupling of the microresonator;
steering, via the reflective component, the microresonator around EPs; and
sending, via the reflective component, one or more phase changes in response to external perturbations back to the microresonator.

19. The method of claim 18, wherein the one or more modes includes a clockwise mode and a counterclockwise mode.

20. The method of claim 18, further comprising:
implementing bidirectional coupling via the bidirectional coupling channel via a Rayleigh scatterer on a surface of the microresonator; and
implementing unidirectional coupling via the unidirectional coupling channel via at least a reflectionless end of a waveguide associated with the microresonator.
